(19) United States
(12) Patent Application Publication
(10) Pub. No.: US 2008/0093531 A1
(43) Pub. Date: Apr. 24, 2008

(54) Structure of image integrated circuit

(76) Inventor: Pei-Sung Chuang, Dan Shui Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/723,417

(22) Filed: Mar. 20, 2007

(30) Foreign Application Priority Data
Oct. 20, 2006 (TW) 095218534

(51) Int. Cl. G01J 1/44

(52) U.S. Cl. 250/206

(57) ABSTRACT

An image integrated circuit includes a light sensor layer and a semiconductor circuit layer. The light sensor layer receives and converts the light of a photographed image and into a corresponding light-induced electrical signal. The bottom of the light sensor layer form conductive terminals for supplying the light-induced electrical signal to the semiconductor circuit layer formed on the bottom of the light sensor layer. The semiconductor circuit layer receives and processes the light-induced electrical signal and in turn generates digital image signal/data so as to realize reconstruction of the image realistically, reducing the cost to produce and layout semiconductor circuits, and reducing the size of the image integrated circuit.

### BACKGROUND OF THE INVENTION

1. Field of the Invention

The present invention generally relates to the field of image integrated circuits, and in particular to a integrated circuit used for image processing, and having a light sensor layer mounted to the top of a semiconductor circuit layer in order to shorten the travel distance of a photographed image.

2. The Related Arts

Digital image integrated circuits are broadly used in a variety of photographing devices, for example, digital cameras, digital video cameras and cell-phones with photographing function. In all these devices, the image integrated circuit converts an analog image into a digital signal for the digital photographing device to process, display and store.

A conventional image integrated circuit is shown in FIG. 1, and is broadly designated with reference numeral 1. The mage integrated circuit 1 comprises a color filter 2, a semiconductor device layer 3 and a sensor layer 4. The color filter 2 is divided into a plurality of filter units 2a, each responsible for filtering the RGB light component of a photographed image. The color filter 2 is located on the top of semiconductor device layer 3. The semiconductor device layer 3 is also divided into a plurality of light lead-in areas 3a corresponding to the filter units 2a of the color filter 2. The light lead-in area 3a has to extend vertically through the semiconductor device layer 3 from top to bottom, allowing the RGB color component filtered through each filter unit 2a to pass through the light lead-in area 3a and come out from the bottom of the semiconductor device layer 3. The sensor layer 4 is located on the bottom of the semiconductor device layer 3, and the surface of the sensor layer 4 has a plurality of sensor units 4a and terminals 4b. Each sensor unit 4a corresponds to one of the light lead-in areas 3a in the of the semiconductor device layer 3 in order to receive the RGB color components filtered through the corresponding filter unit 2a of the color filter 2. The sensor units 4a detect the light component and produce an image light-induced electrical signal that is outputted through the terminal 4b. The terminal 4b is connected to the interior circuit of the semiconductor device layer 3 to supply the image light-induced signal to the semiconductor device layer 3 for processing, and the semiconductor device layer 3 in turn outputs digital image signal/data.

In the manufacturing process of the conventional image integrated circuit 1, the light lead-in areas 3a that are provided in the integrated circuit 1 make it necessary for the semiconductor devices and circuit layout of the integrated circuit 1 to be arranged in such a way not to conflict in location with the light lead-in areas 3a. Because of the above reason, it makes the arrangement of the semiconductor devices and circuit layout in the integrated circuit 1 extremely difficult, and additional layers may be needed for constructing the specific integrated circuit 1. This forces the size of the semiconductor device layer 3 to become thicker, causing the costs and size of image integrated circuit 1 to increase, and makes it inconvenient to use in digital photographing device industry.

Also referring to FIG. 2, when the conventional image integrated circuit is actually applied in photographing operations, the light A of a photographed image has to first go through a lens 5, which refracts the light A toward the color filter 2, the light lead-in areas 3a of the semiconductor device layer 3 and finally reaching the sensor layer 4. Through the long optic path along which the light A travels, the light may get incident to the light lead-in areas 3a of the semiconductor device layer 3 in a tilted angle, causing the light intensity of the image to attenuate, as well as color distortion. Because of the above reason, the image data obtained by the sensor units 4a of sensor layer 4 may include problems such as blurring, reduced brightness and color distortion. Thus, compensating circuits are needed to work with the image integrated circuit 1 to stimulate compensation and correction of the image data. However, the compensating and correction cannot perfectly rebuild the image, causing the conventional image integrated circuit 1 used in photographing not able to obtain good photographing quality.

In the previous references, such as US Patent Publication No. 2005/0067668, entitled “Color Filter of Image Sensor, Image Sensor, and Method for Manufacturing the Image Sensor”, which discloses a conventional image integrated circuit structure, although the known image integrated circuit structure adds an intermediate layer containing metal-wire layouts between the semiconductor layer and the color filters to improve the quality of the image obtained, yet this extends the optic path of the photographed image, causes attenuation of light of the image and makes color distortion worse. Further, the size and volume of the image integrated circuit has to increase, and making it even harder and more costly to set up the semi-conduction layouts.

### SUMMARY OF THE INVENTION

Thus, an objective of the present invention is to provide a structure of image integrated circuit, in which a light sensor layer is directly mounted to the top of a semiconductor circuit layer so as to minimize the optic path of the photographed image, maintain the light intensity of the photographed image without causing attenuation of the light intensity, and perfectly show the real image and color quality.

Another objective of the present invention is to provide a structure of integrated circuit, which does not need to install any light lead-in area/duct, so as to allow the semiconductor devices and the circuit layout design of the semiconductor circuit layer to become simpler and reducing the cost of semiconductor device and circuit layout designing.

A further objective of the present invention is to provide a structure of integrated circuit, of which the size is significantly reduced in order to be used by the digital photographing industry.

To realize the above objectives, the present invention provides an image integrated circuit comprising light sensor layer and a semiconductor circuit layer, wherein the light sensor layer receives and converts the light of a photographed image and into a corresponding light-induced electrical signal for output. The bottom surface of the light sensor layer is provided with a plurality of conductive terminals for outputting the light-induced electrical signal. The semiconductor circuit layer is connected to the conductive terminals on the bottom of the light sensor layer to supply the light-induced electrical signals to the semiconductor circuit layer. The semiconductor circuit layer receives and processes the light-induced electrical signal and generates in turn digital image signal/data so as to realize reconstruction of the image realistically, reducing the cost to produce and layout semiconductor circuits, and reducing the size of the image integrated circuit.

These and other objects, features, and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention will be apparent to those skilled in the art by reading the following description of preferred embodiments thereof, with reference to the attached drawings, wherein:

FIG. 1 is an exploded view of a conventional image integrated circuit;

FIG. 2 is a cross-sectional view of the image integrated circuit of FIG. 1, together with a lens that focuses received light onto the conventional image integrated circuit;

FIG. 3 is a perspective view of an image integrated circuit constructed in accordance with a first embodiment of the present invention;

FIG. 4 is an exploded view of the image integrated circuit of FIG. 3;

FIG. 5 is a cross-sectional view of the image integrated circuit of FIG. 3;

FIG. 6 is a cross-sectional view similar to FIG. 5, illustrating the optic path of a photographed image of the image integrated circuit;

FIG. 7 is a perspective view of an image integrated circuit constructed in accordance with a second embodiment of the present invention;

FIG. 8 is an exploded view of the image integrated circuit of FIG. 7;

FIG. 9 is a cross-sectional view of the image integrated circuit of FIG. 7;

FIG. 10 is a cross-sectional view similar to FIG. 9, illustrating the optic path of a photographed image of the image integrated circuit; and

FIG. 11 is a cross-sectional view showing a digital camera in which the image integrated circuit of the present invention is applied.

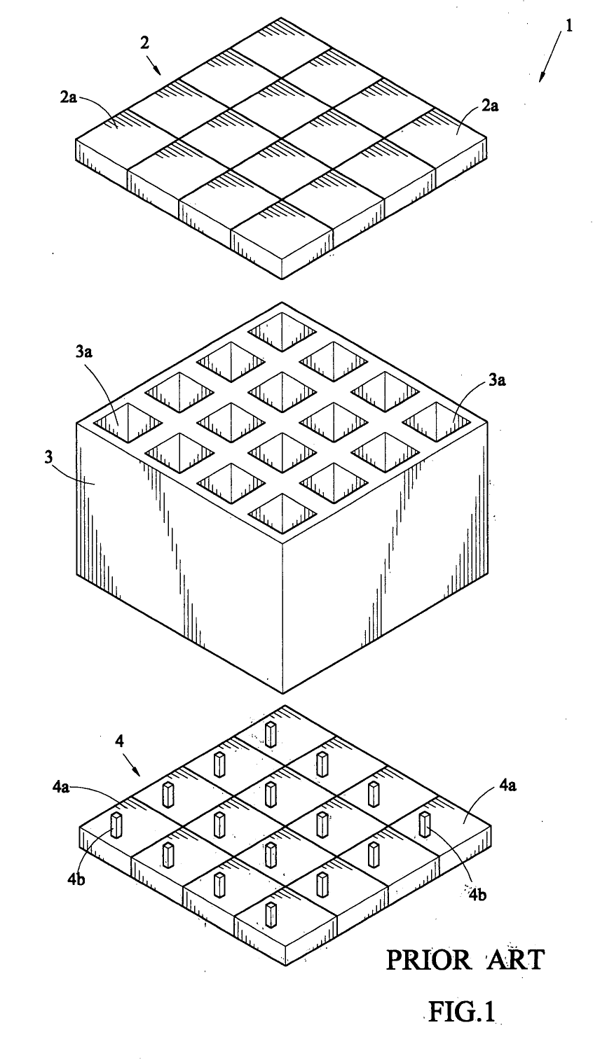

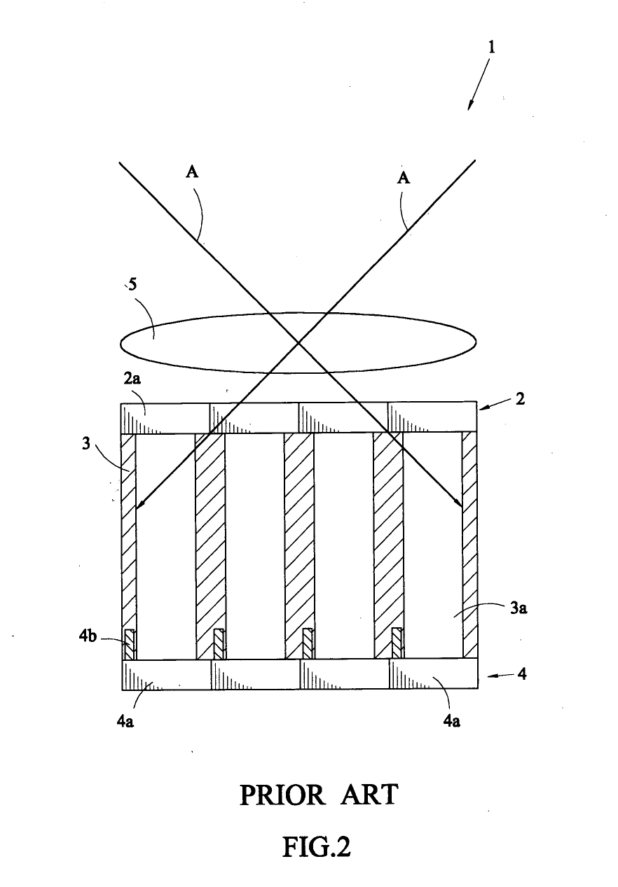

### DETAILED DESCRIPTION OF THE PREFERRED EMBODIMENTS

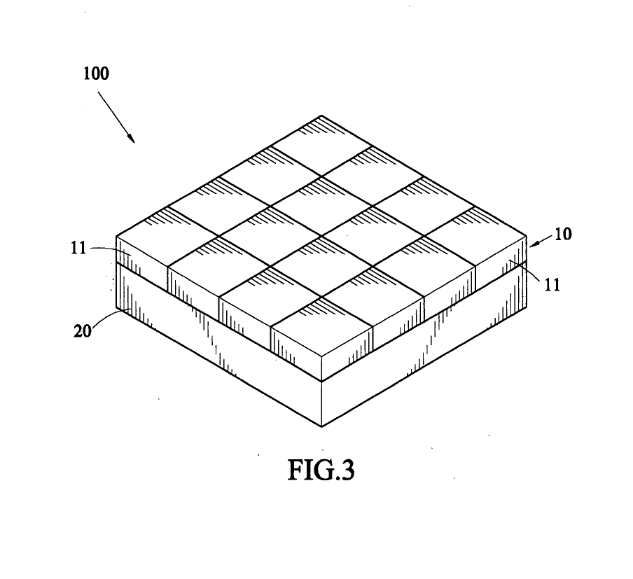

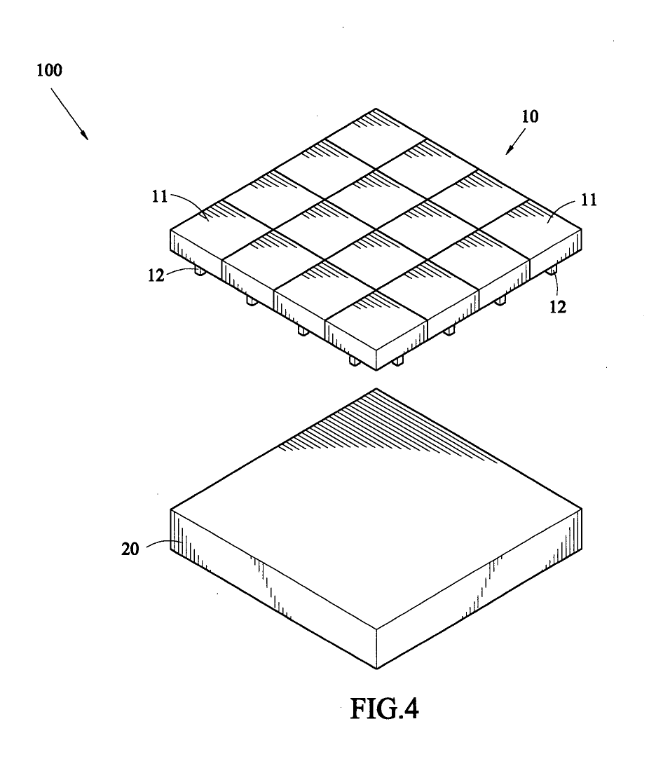

With reference to the drawings and in particular to FIGS. 3 and 4, which show an image integrated circuit 100 constructed in accordance with a first embodiment of the present invention, the image integrated circuit 100 comprises a light sensor layer 10, which contains a plurality of sensor units 11, each detecting light that forms a photographed image and converting the light into a corresponding light-induced electrical signal for output and storage of electric charge thereof. Underneath the light sensor layer 10, a plurality of conductive terminals 12 are formed, each connected to each sensor unit 11 and transmits the light-induced electrical signal for output.

A semiconductor circuit layer 20 is mounted to the bottom of light sensor layer 10. The semiconductor circuit layer 20 contains a plurality of semiconductor devices and circuit layouts, providing the functions of digitalizing and outputting image signals. The top of the semiconductor circuit layer 20 is connected to the conductive terminals 12 beneath the light sensor layer 10, and the connection allows the light-induced electrical signal produced by each sensor unit 11 of the light sensor layer 10 to be transmitted to the corresponding semiconductor devices and circuit layouts inside the semiconductor circuit layer 20 for subsequent processing in order to produce the digital image signal/data corresponding to the photographed image.

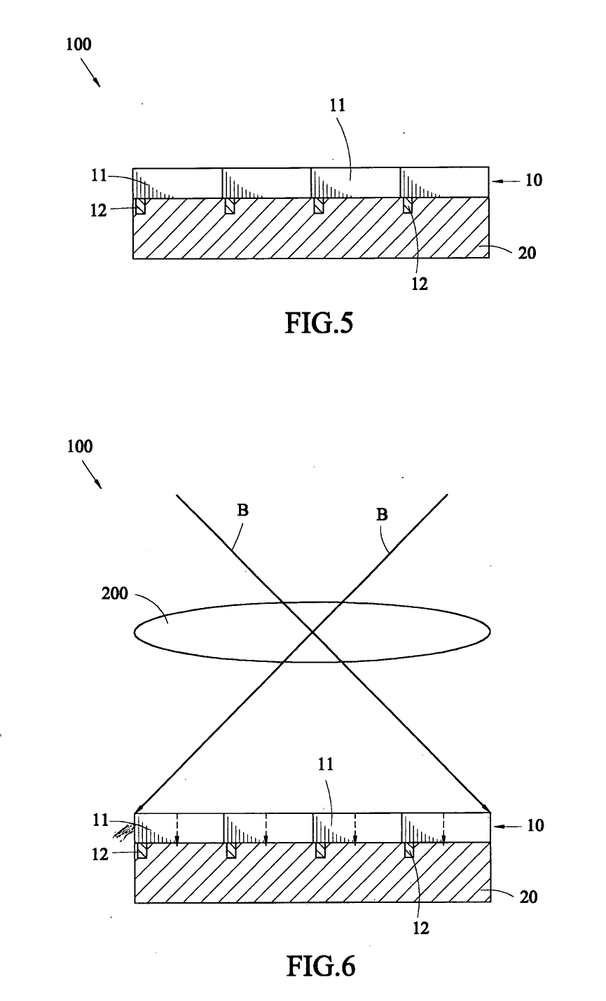

Also referring to FIGS. 5 and 6, which show an optic path of the photographed image of the first preferred embodiment of the present invention shown in FIG. 3 and FIG. 4, the light B of the photographed image goes through a lens 200 where it focuses and refracts the light B toward the sensor units 11 of the light sensor layer 10, allowing the light B to travel the shortest route toward the image integrated circuit 100 without the provision of any light lead-in area or light channels. This mechanism can realistically reconstruct the light quality of the photographed image and gray color, and greatly reduce the cost of the follow-up on stimulating the compensate design.

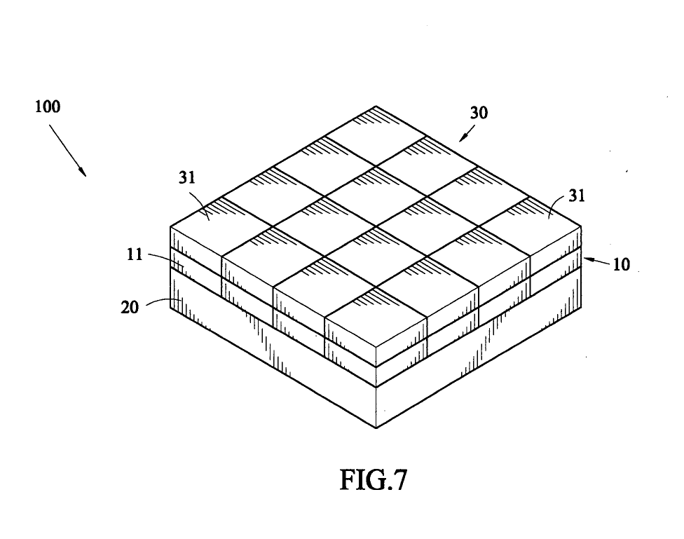

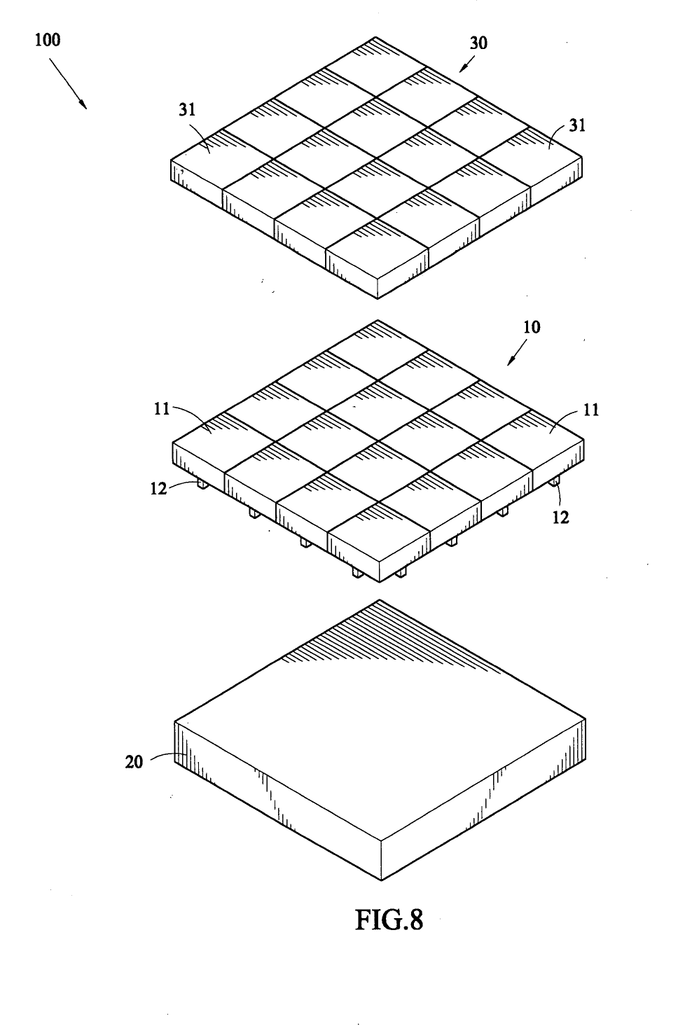

FIGS. 7 and 8 shows an image integrated circuit in accordance with a second embodiment of the present invention, which is also designated with reference numeral 100 for simplicity. The image integrated circuit 100 of the second embodiment comprises a light sensor layer 10 and a color filter layer 30 that contains a plurality of filter units 31 mounted to a top of the light sensor layer 10. Each filter unit 31 is used to filter out the red, green and blue color light components of the photographed image and to feed out the filtered light of the photographed image through the bottom of each filter unit 31.

The sensor unit 11 of the light sensor layer 10 receives the filtered color light of the photographed image that comes through the bottom of the filter unit 31 of the color filter unit 30, and converts it into the respective light-induced electrical signal for output and electric charge for storage. The conductive terminals 12 beneath the light sensor layer 10 then transmit the light-induced electrical signal produced by each sensor unit 11 into the semiconductor circuit layer 20 for subsequent processing to provide corresponding digital image signal/data for the photographed image.

The connection between the light sensor layer 10 and the color filter layer 30 is not limited to any specific type. Adhesives based bonding is taken as an example of illustrated herein. Other equivalent structure, such as forming the color filter layer on the light sensor layer 10 by coating is also applicable in the present invention.

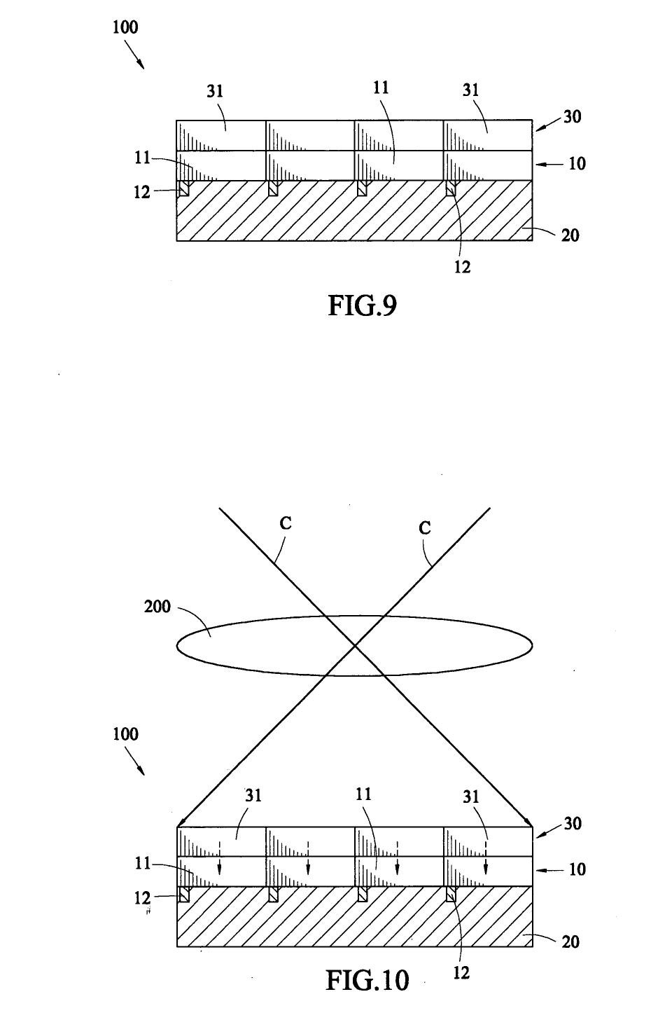

FIGS. 9 and 10 show an optic path of the photographed image of the second embodiment of the image integrated circuit as shown in FIGS. 7 and 8. The light C of the photographed image goes through a lens 200 where it focuses and refracts the light C directly toward the color filter layer 30 (along the direction indicated by the arrow of FIG. 9), and the light C transmits through the color filter layer 30 to allow the filtered color light of the photographed image to reach the sensor units 11 of the light sensor layer 10 directly, whereby the light C travels the shortest route toward the image integrated circuit 100. This mechanism can realistically reconstruct the light quality of the photographed image and gray color, and greatly reduce the cost of the follow-up on stimulating the compensate design.

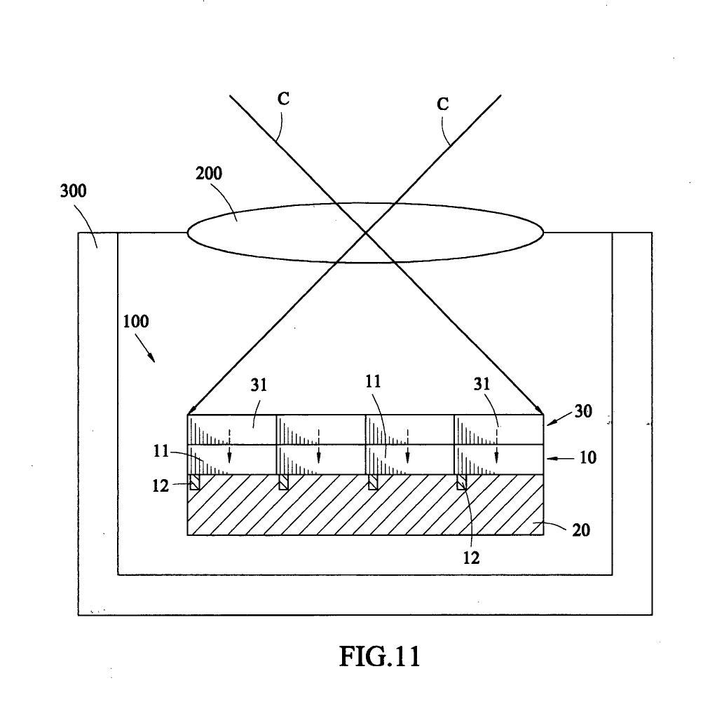

As shown in FIG. 11, an example of application of the image integrated circuit 100 in accordance with the present invention is demonstrated. The image integrated circuit 100 is applicable to and arranged in the interior of a digital camera 300. Since the combination size of the color filter layer 30, the light sensor layer 10, and the semiconductor circuit layer 20 is greatly reduced, and the producing cost and layout design cost is also lowered. This makes the image integrated circuit 100 perfectly fit for the digital camera 300, and allowing the digital camera 300 to have a small size and light weight.

The image integrated circuit structure described herein with reference to FIGS. 3-11 is provided for explanation of the principle of the present invention, not to limit the scope of present invention, which is only interpreted by reading the appended claims.

Although the present invention has been described with reference to the preferred embodiments thereof, it is apparent to those skilled in the art that a variety of modifications and changes may be made without departing from the scope of the present invention which is intended to be defined by appended claims.

What is claimed is:

1. An image integrated circuit comprising:
a light sensor layer, which receives and converts light of a photographed image into respective light-induced electrical signal for output and electric charge for storage, a bottom of the light sensor layer forming a plurality of conductive terminals through which the light-induced signals are outputted; and
a semiconductor circuit layer mounted to the bottom of the light sensor layer and connected to the conductive terminals formed on the bottom of the light sensor layer to receive and process the light-induced signal supplied by the light sensor layer so as to produce corresponding digital image signal/data.

2. The image integrated circuit as claimed in claim 1, wherein the light sensor layer comprises a plurality of sensor units.

3. The image integrated circuit as claimed in claim 1 further comprising a color filter layer formed on a top of the light sensor layer.

4. The image integrated circuit as claimed in claim 3, wherein the color filter layer is adhesively bonded to the light sensor layer.

5. The image integrated circuit as claimed in claim 3, wherein the color filter layer is coated on the light sensor layer.

6. The image integrated circuit as claimed in claim 3, wherein the color filter layer comprises a plurality of filter units.
